(19) United States
(12) Patent Application Publication
(10) Pub. No.: US 2003/0225926 A1
(43) Pub. Date: Dec. 4, 2003

(54) Collaboration envelopes: a method to improve collaborative sensemaking

(75) Inventor: John T. Nosek, Haddonfield, NJ (US)

Correspondence Address: Dr. John T. Nosek, SenseMaking Technologies Corp., 215 Redman Ave., Haddonfield, NJ, 08033, US

(73) Assignee: SenseMaking Technologies Corp., Horsham, PA

(21) Appl. No.: 10/158,300

(22) Filed: May 30, 2002

(51) Int. Cl. G06F 9/44

(52) U.S. Cl. 709/317

(57) ABSTRACT

The present invention disclosed comprises a method for providing collaboration functionality to support sensemaking capabilities of participating agents within a collaboration and among collaborations. The invention enhances the ability of participating agents to maximize their sensemaking effectiveness as they work within a collaboration and supports the shifting among collaborations. Each participating agent may initiate Collaboration Envelopes™ within many collaborations. It is possible to have multiple Collaboration Envelopes™ initiated simultaneously to support shifting among collaborations. Collaboration Envelopes™ can maintain Collaboration State Properties with customized views for each participating agent so that participating agents may ascertain what has changed in collaboration state properties since the last time that the participating agent evaluated them. Within Collaboration Envelopes,™ files can be dynamically categorized to support rationale building. Customized Collaboration Components can be added to Collaboration Envelopes™. An illustrated example is the integration of AI Processing Components with collaboratively enhanced inputs and outputs.

### TECHNICAL FIELD OF THE INVENTION

The present invention pertains in general to computer software, and more particularly, to improving collaboration using Collaboration Envelopes™.

### BACKGROUND OF THE INVENTION

New collaboration-centric applications that incorporate similar collaboration functionality in different ways can place heavy demands on users to learn, and organizations to train. Taking a lesson from the success of the Windows-based metaphor that is used across a range of applications to perform similar common file functions such as opening and saving, the notion of a Collaboration Envelope™ is introduced. Collaboration Envelopes™ provide common collaboration functionality across a range of applications in similar ways to improve collaborative sensemaking and reduce training requirements. First, sensemaking is explained through a Framework of Sensemaking Cycles and Linkages. Second, using the Sensemaking Framework, the notion of a Collaboration Envelope™ to seamlessly support individual and multi-level sensemaking activities is introduced.

Single Sensemaking Cycle by Individual Agent

While aggregates can project a signal (which will be described subsequently), it is critical to remember that processing to make sense of a signal needs to occur at the individual-agent level. While many individual agents within an aggregate can be processing the same signal at the same time, although not necessarily in the say way, the aggregate, like a team or organization, can not process a signal. Before describing multi-level sensemaking and linkages, we briefly identify issues relevant to a single sensemaking cycle, which are basic to all levels of sensemaking. See FIG. 1 below for an abstraction of a single sensemaking cycle.

[image]

Signal Out is the action or the constructed boundary object (something an agent consciously or subconsciously externalizes, like a message, picture, gesture . . . ). A Signal Out:

1) may or may not be attended to by other agents.

2) must be generated at the right time.

3) must be directed to the right agents while denying it to the wrong agents.

4) transmitted by the sending agent is affected by such factors, as: degree that a sending agent evaluates that receiving agents do not share the same meaning of a situation, effort to transmit, available means to transmit, effectiveness of means, trust of receiving agents, dependence on receiving agents to accomplish sending agent's goals, task importance, time to achieve shared meaning, task equivocality, etc.

Signal In is the affordance of a boundary object, i.e., something external to the cognitive domain and observable by an agent. A Signal In:

1) must be received at the right time.

2) must be received from the right agent/s.

3) may be actively pulled in by the receiving agent.

4) may be the result of an action by the receiving agent to uncover/clarify signals.

5) must have sufficient signal strength, i.e., the inherent properties of the signal to project clearly over the noise in the environment.

6) is affected by receiving agent factors, such as: sensing capabilities, cognitive workload, working memory capacity, goals, and hypotheses.

Constructing Meaning (Make Sense): Some factors that affect the process of construing meaning of a received signal include:

1) available knowledge to process signal, i.e., the episodic nature of elicited/accessible knowledge determines what knowledge is available within working memory for sensemaking,

2) cognitive constructs of receiving agent,

3) task importance to which the signal is related,

4) some cognitive limitations mentioned above related to Signal In affect making sense of the signals: cognitive workload, working memory capacity, goals, and hypotheses,

5) additional factors that affect meaning construction include: beliefs, trust in origin, and dependence on others, relative to the sign, i.e., how does the Signal In affect a dependence that the receiving agent may have with other agents.

Not surprisingly, there are a number of cognitive processing factors that overlap in attending to Signals In, making sense of these signals, and constructing and conveying Signals Out. However, it is important to understand how some of these overlapping aspects of cognitive processing affect the constituent processes within the overall sensemaking cycle.

Levels and Linkages

A primary reason for failure to act effectively in ill-structured domain situations is failure in sensemaking at the individual, team, organizational, and inter-organizational levels. Sensemaking cycles must be linked among individuals within a team, the team must link the results of their sensemaking cycles to other teams in the organization by linking with one or more agents of those teams, and the organization must link their sensemaking cycles to agents within other organizations. FIG. 2 below provides an abstraction of these sensemaking levels and linkages. In one way, the framework can be viewed as layering socio-cognitive cycles over the General Systems Theory Model with at least two important and useful distinctions:

1) As opposed to Systems Theory where the output of one system is the input to another system, the Signal In to systems is not necessarily perceived as being the same as the intended Signal Out of another system. This is why they are represented in different colors, although the colors themselves are insignificant. In addition, if the right agent does not receive the Signal Out at the right time, it is functionally a “lost” signal.

2) As noted earlier, while a higher level aggregate, such as a team can create a single output signal, like a document, warning, or joint action, this can only be perceived by individual agents, both human and non-human, within other higher level aggregates, such as teams or organizations.

[image]

Collaboration Envelopes™

There must be an intellectual break away from the notion of individual tools that incorporate collaboration functionality in their own unique ways in a non-integrative fashion. The notion of a Collaboration Envelope™ is introduced as a way to envision technology that seamlessly wraps around cognitive work to augment individual-agent and aggregate sensemaking cycles. Table 2 provides a summary comparison between tool-centric and Collaboration Envelope™ Technology.

TABLE 1
Tool-centric versus Collaboration Envelopes ™

| | | Collaboration |
|---|---|---|
| Dimension | Tool-centric | Envelopes ™ |
| Degree of | Very limited, | High, integration |
| Integration | mostly stand-alone | of functions |
| Effort to | High, separate | Low, integrated |
| Learn | unfamiliar environments | environment with similar, |
| | to learn | familiar interfaces |
| Flexible | Low, limited to | High, permits flexible, |
| Perspective | perspective of | multiple perspectives |
| Taking | the individual tool | of work activity |

It is useful to view augmentation with Collaboration Envelopes™ at three levels:

Level 1: Sharing Signals, both Signals In and Out. This level of cognitive augmentation is very limited. The focus is on sharing data. In this way, at least it is easier to retrieve external memories incorporated in artifacts such as documents and maps and easier to communicate with others who have the ability to access the same artifacts. Both military and civilian collaboration solutions have focussed on tool-centric ways to overcome the fact that everyone can not be in the same room at the same time, using the same file cabinets. A Level 1 Collaboration Envelope™ supports data sharing, but in a way that is non-tool-centric and more of a natural wrapper to share artifacts.

Level 2: Level 1, plus more directly addressing human cognitive limitations, without the use of non-human agents. It is useful to further subdivide this level into two sub-levels: Core and Advanced.

Core: This technology addresses the issues of cognitive workload associated with attending to Signals In and directing Signals Out. For example, 1) Signals In Augmentation: Technology that reduces attention work, by filtering unwanted Signals In or clarifying and enhancing more relevant Signals In, such as dynamic comparisons of artifacts to identify differences since the last time the agent processed the artifacts or differences in competing alternatives; 2) Signals Out Augmentation: Technology that makes it easier to direct signals, propose alternatives, etc.

Advanced: This technology focuses more on helping to make sense of signals as agents collaboratively integrate and construct meaning. It includes such things as aid in organizing and labeling data, integration of Signals In by multiple individual agents and aggregates, and incorporating techniques such as cognitive modeling, consensus building, strategic assumption surfacing, etc.

Level 3: Level 2, plus integrates non-human agents in augmenting sensemaking cycles. It is also useful to further subdivide this level into two sub-levels: Core and Advanced.

Core: This is the use of simple computerized agents that perform simple actions. These programs incorporate simple rules and generally do not “learn.” Examples of this technology, may be agents that search the web for certain key words.

Advanced: This includes technology that directly extends the workload capacity of humans and mitigates weaknesses due to working memory limitations and the episodic nature of accessible knowledge. Since sensemaking deals with incomplete, conflicting data, existing AI techniques are not very useful. Situational logic-based technology and artificial intelligence incorporating non-axiomatic reasoning are exciting, innovative approaches that offer great promise in this area. For example, using non-axiomatic reasoning, new agents could be spawned for existing and hypothetically generated Signals In and spawned again for various assumptions. This directly multiplies the capacities of humans to generate different sets of knowledge for variations in data sets.

SenseMaker™, a Collaboration Envelope™ built on Collaboration Engine™ (patent pending) Technology and developed by SenseMaking Technologies Corporation would be classified as a Level 2, Core Collaboration Envelope™ with some advanced features in categorizing and labeling that help to integrate contributions from multiple agents. SenseMaker™ supports the goal of seamlessness by allowing individual human agents to construct artifacts using whatever tool is most cognitively comfortable, while providing a consistent, easy-to-use, and easy-to-learn interface for a variety of sensemaking activities.

Supporting Work Within and Between Collaborations

Agents, human and non-human, may participate in multiple collaborations with different participants in parallel, switching among various collaborations. In some sense, an agent may even engage in a collaboration with himself. For example, during reflection on an issue, one's perspective and understanding may have changed since the last time the issue was visited. FIG. 3 below shows a schematic of how an agent is part of a collaboration at one time, Time 1, and then through some change in attention, becomes part of another collaboration. Collaboration Envelopes must support the process of working within a collaboration and then shifting attention and working effectively within another collaboration.

[image]

Collaboration Envelopes™ help build and maintain an understanding by each member of the group. Participant agents possess inherent working memory limitations that severely hinder sensemaking. Working memory has (1) limited capacity and (2) knowledge available within it is episodic, i.e., knowledge available shifts with signals received and the reflective processing of signals so that what knowledge is constructed available for processing signals within working memory at a given time changes. There must be ways to support sensemaking (Signals-In, Signals-Out, and Making Sense) within a Collaboration and between Collaborations. For example, within a collaboration, agents must be aware of important Signals Out at the right time, and at the same time, be open to important signals coming from another collaboration to shift attention at the right time. To quickly make sense of these signals at the right time, there must be mechanisms that allow participating agents to understand what may have changed in the collaboration since the last time the agent was engaged within the collaboration, i.e., changes will occur within a collaboration that will affect the sensemaking state of a participating agent and these mechanisms must allow individual participating agents to understand changes in the state relative to their last sensemaking state within a collaboration.

FIGS. 4 depicts the ideas of understanding changes in collaboration state by looking at one state property of a collaboration, an artifact, that is being collaboratively constructed at different times by different participating agents.

[image]

FIG. 5 depicts how a participating agent must be able to evaluate changes since the last time the agent was engaged within the collaboration, evaluated the Collaboration State Property, and perhaps modified it. This means that the participant who re-engages within a collaboration is not necessarily interested in all the incremental changes since the last time of engagement. The agent made judgments in reviewing a Collaboration State Property at a given point in time, the Collaboration State Property may have changed within a collaboration, now the agent must be supported to quickly evaluate what changes may have been made to the Collaboration State Property since the last evaluative act. Referring back to FIG. 4, at some initial time a Version 1 of a Collaboration State Property was created by Agent 1 and distributed to three other agents. Following this, Agent 2 evaluates and suggests modifications to Version 1 of the Collaborative State Property. While Agent 1 incorporates changes of Agent 2 and creates a new version, Version 2, Agent 3 evaluates and suggests modifications to Version 1. While Agent 1 compares the suggested modifications of Version 1 submitted by Agent 3 to the current version, Version 2 and creates a new version, Version 3, Agent 4 evaluates and suggests changes to Version 2. Agent 1 then compares the suggested changes to Version 2 submitted by Agent 4 against the current version, Version 3 and creates a new version, Version 4. Referring now to FIG. 5, when Agent 2 re-engages within the collaboration, Agent 2 must compare Version 4 against the last version that Agent 2 evaluated, Version 1 plus the suggested changes of Agent 2. When Agent 3 re-engages within the collaboration, Agent 3 must compare Version 4 against the last version that Agent 3 evaluated, Version 1 plus the suggested changes of Agent 3. Finally when Agent 4 re-engages within the collaboration, Agent 4 must compare Version 4 against the last version that Agent 4 evaluated, Version 2 plus the suggested changes of Agent 4.

[image]

Extensibility

Since a major goal of a Collaboration Envelope™ is to seamlessly support deep thinking naturally, the choice of a Collaboration Envelope™ should always consider the extensibility of the technology to incorporate higher levels of support. This issue can not be overly emphasized. Organizations that want to continually enhance individual and multi-level sensemaking to achieve and/or sustain competitive advantage must have a way to upgrade capabilities in a way that does not degrade existing sensemaking activities. Acceptance of this notion of natural, integrated support, is rejection of the accretion of new, non-integrated tools that hamper existing sensemaking while offering the often-unfulfilled promise of better performance. The cost/benefit of any new functionality must be a gradual slope where benefits outweigh the cost of learning and using. SenseMaker™, a Collaboration Envelope™ developed by SenseMaking Technologies Corporation, was specifically designed to be fully extensible to naturally integrate continual enhancements while supporting existing sensemaking activities.

### SUMMARY OF THE INVENTION

As noted earlier, for the most part, non-Collaboration Envelope™ technologies focus on sharing data and not on supporting the sensemaking activities of participants engaged in a collaboration.

The present invention disclosed comprises a method for building software to fully support the sensemaking activities of participants who engage in single or multiple collaborations. A major aspect of the invention is the ability for agents, both human and non-human, to be supported in their sensemaking activities as they participate in one collaboration and need to move among other collaborations. Other processes that are aspects of this invention include, but are not limited to, the following:

1) The aspect that a Collaboration Envelope™ for an individual agent is customized to help the agent maintain the state of the agent's sensemaking within a collaboration and support the agent's ability to understand changes within the collaboration that affect the state of the individual agent's sensemaking process.

2) The aspect of having multiple Collaboration Envelopes™ active at a given time.

3) The aspect of shifting from one Collaboration Envelope™ to another Collaboration Envelope™.

4) The aspect of having the Collaboration Envelope™ support the construction of appropriate Signals Out to the right agent at the right time.

5) The aspect of having the Collaboration Envelope™ support the reception of appropriate Signals In by the right agent at the right time.

6) The aspect of assisting agents in making sense of Signals In.

7) The aspect of attention mechanisms within Collaboration Envelopes™ to guide attention within a collaboration and those to support the shifting of attention among Collaboration Envelopes™.

8) The aspect of accessing these Collaboration Envelopes™ from any computer that has access to other computers that are connected in some manner, either wired or wireless, over local area networks, intranets, or the internet.

9) The aspect that access to Collaboration Envelopes™ that are not on a local computer that is connected to other computers in some way may be accessed without loading specialized software on the client machine.

10) The aspect that means exist within Collaboration Envelopes™ to help participating agents achieve changes in state between engagements within a collaboration by ascertaining the changes in Collaboration State Properties for a participating agent from one engagement within a collaboration to another engagement within a collaboration.

11) The aspect that means exist within Collaboration Envelopes™ to dynamically build categories for files to support rationale building that occurs within sensemaking.

12) The aspect that advanced Collaboration Envelopes™ can include artificial intelligence mechanisms to extend agent processing.

13) The aspect that input into included artificial intelligence mechanisms can be collaboratively enhanced.

14) The aspect that output from included artificial intelligence mechanisms can be clarified through collaborative enhancement.

### BRIEF DESCRIPTION OF THE DRAWING

For a more complete understanding of the present invention and the advantages thereof, reference is now made to the following description taken in conjunction with the accompanying drawings in which:

FIG. 1 illustrates an overall block diagram of the system of the present invention;

FIG. 2 illustrates an overall block diagram of a network of computers;

FIG. 3 illustrates the components of a Collaboration Envelope™ that extends the cognitive capabilities of participants within a collaboration;

FIG. 4 illustrates how each participant agent within a Collaboration Envelopes™ has its own Collaboration Envelope™;

FIG. 5 illustrates how a participating agent moves among Collaborations;

FIG. 6 illustrates the integration of a specialized Artificial Intelligence Collaboration Component within a Collaboration;

FIG. 7 illustrates the initiation and spawning of specialized Artificial Intelligence Collaboration Components to overcome limitations of agents to simultaneously follow multiple inference chains.

FIG. 8 illustrates a flowchart that depicts the operation wherein a participating agent evaluates changes in a collaboration state property since the last evaluation.

FIG. 9 illustrates a flowchart that depicts the operation wherein files can be dynamically categorized in rationale building that occurs within sensemaking.

### DETAILED DESCRIPTION OF THE INVENTION

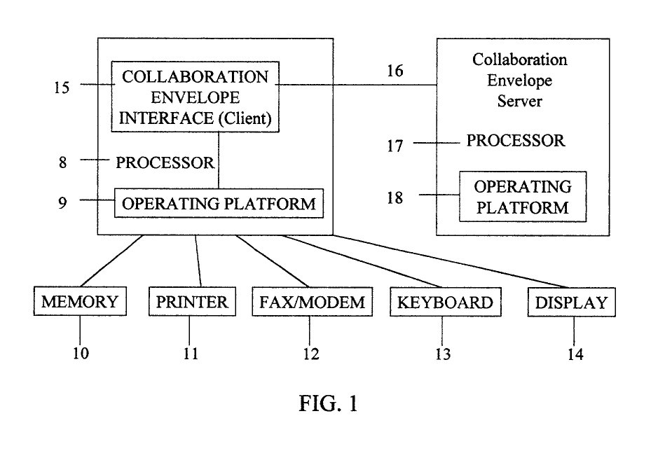

Referring now to FIG. 1, there is illustrated Collaboration Envelope™ Interface (Client) 15 that runs in a general processor-based computer 8, which can be any type of conventional, all-purpose, or specialized digital computer, which will be referred to subsequently as “computer,” that is capable of running an interface to the Collaboration Envelope™ Server 16 that usually runs separately on a general processor-based computer 17, which can be any type of conventional, all-purpose, digital computer from where the Collaboration Envelope™ Interface (Client) 15 runs, but may run on the same computer 8. The computers 8 and 17 have associated with it the necessary hardware to execute various instructions associated with application programs. These typically require some type of processor, the circuitry required to run the processor, memory, both Random Access Memory and Mass Storage Memory in the form of hard disks, and input/out structure. The computer 8 is operable to receive instructions external to the processor from a peripheral device such as a keyboard 13 to load a program from an external memory device 10 into operating memory (not shown). The computer 17 would have similar capabilities as computer 8 to receive instructions external to the process form a peripheral device such as a keyboard to load a program from an external memory device into operating memory (not shown).

The system of the present invention is basically comprised of Collaboration Envelope™ Interface (Client) 15 which operates on an operating platform 9 and interfaces with Collaboration Envelope™ Server 16 that can run on the same computer 8 or on a separate computer 17. The Collaboration Envelope™ Interface (Client) 15 and Collaboration Envelope™ Server 16 together provide collaboration functionality to support sensemaking capabilities within a collaboration and between collaborations. In the present embodiment, the operating platform is a Windows™ platform that in general provides for control of the majority of the input/output devices, etc. This is a conventional, widely used operating platform; however, Collaboration Envelope™ Interface (Client) 15 and Collaboration Envelope™ Server can be applied to a variety of operating platforms. The operating platform 9 is operable to interface with an external printer 11, a FAX/modem device 12, a keyboard 13, and a display 14. Computer 17 would operate in a similar way (not shown). Again, this operation is conventional.

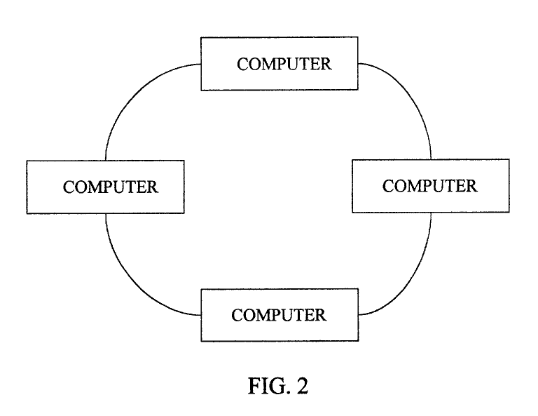

As noted earlier Collaboration Envelope™ Interface (Client) 15 and Collaboration Envelope™ Server 16 can be used as a stand alone program on a single computer, referring now to FIG. 1, but can also be run on a computer as a server which can provide services to other computers that are connected to it via some connection such as, but not limited to, a local area network, internet, intranet, etc., referring now to FIG. 2. Collaboration Envelope™ Server 16 runs on a digital computer in such a way that any computer can act as a server to other computers as long as the computers are connected in some way so that data can be transmitted among computers. In addition, Collaboration Envelope™ Server 16 can be distributed among many computers as long as the computers are connected in some way so that data can be transmitted among computers.

As noted earlier, Collaboration Envelope™ Interface (Client) 15 operates over the operating platform 9 and requires the operating platform 9 in order to operate. In a similar way Collaboration Envelope™ Server 16 operates over the operating platform 18 and requires the operating platform 18 in order to operate. Collaboration Envelope™ Server 16 is made up of components that work in concert to provide Collaboration Envelopes™ for each participant. A participant can connect to many Collaboration Envelope™ Servers that provide separate customized Collaboration Envelopes™ for each participant for each collaboration.

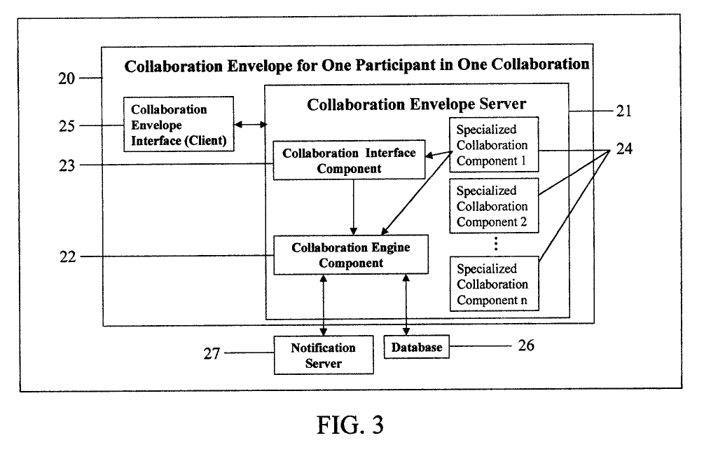

Referring now to FIG. 3, there is illustrated a diagram that shows the components of One Collaboration Envelope™ for One Participant in One Collaboration 20 that provide support for the participant to overcome cognitive limitations in optimizing performance within a collaboration and among collaborations by shifting among Collaboration Envelopes™. A Collaboration Envelope™ overcomes cognitive limitations of working memory by providing support for a participating agent to quickly understand the current state within a collaboration since the agent's last participation within it. Although there may be many participating agents within a collaboration, the Collaboration Envelope™ components provide a customized envelope for each participant. While this invention is for the process of Collaboration Envelopes™ that can be implemented in a variety of ways, one way of implementing this invention of the Collaboration Envelope™ is described as follows: When a Collaboration Envelope™ is invoked a new Collaboration Envelope™ Server 21 is instantiated which causes separate instances of the Collaboration Envelope™ Server Components: Collaboration Engine Component 22, Collaboration Interface Component 23, plus any number of Specialized Collaboration Components 24 that are incorporated within a collaboration. For example, specialized components may include components that wrap around applications such as Word, Excel etc. to manage shared work products and their status for this participant, or there may be separate specialized components for a collaboration that support where a participant is in within a brainstorming or cognitive mapping session. A shared work product can be anything presentable in at least one dimension by some output device, this means it is media independent.

The end users interact within a Collaboration Envelope™ through a Collaboration Envelope™ Interface (Client) 25. This Collaboration Envelope™ Interface (Client) 25 can be a separate program on the client machine, be a window within an existing web browser on a client machine, or some other programming interface that permits communication between the client machine and the Collaboration Envelope™ Server 21. The Collaboration Interface Component 23 manages the interactions between the participant's Collaboration Envelope™ Interface (Client) 25 and the Collaboration Envelope™ Server 21. There is a login process where the Collaboration Interface Component 23 interacts with the Collaboration Engine Component 22. Any Specialized Collaboration Components 26 interact with Collaboration Interface Component 23 and the Collaboration Engine Component 22. The Collaboration Engine Component 22 interacts with a Database 26 in a conventional manner to persist information. The Collaboration Engine Component 22 interacts with the Notification Server 27 for a given collaboration. The Notification Server 27 handles notifications within a collaboration. Collaboration Engine Component 22 interacts with a storage medium, Database, 26 that is sharable with other clients and the Notification Server 24 that provides updates to all collaboration engines connected to the notification serer. Where the collaboration engine, database, and notification server reside is independent. For example, they can all reside on a single machine for single user operations; they can all reside on different machines. For example, a collaboration engine for a user may be running on one machine and the user is providing input to this instance of the collaboration engine with some input device.

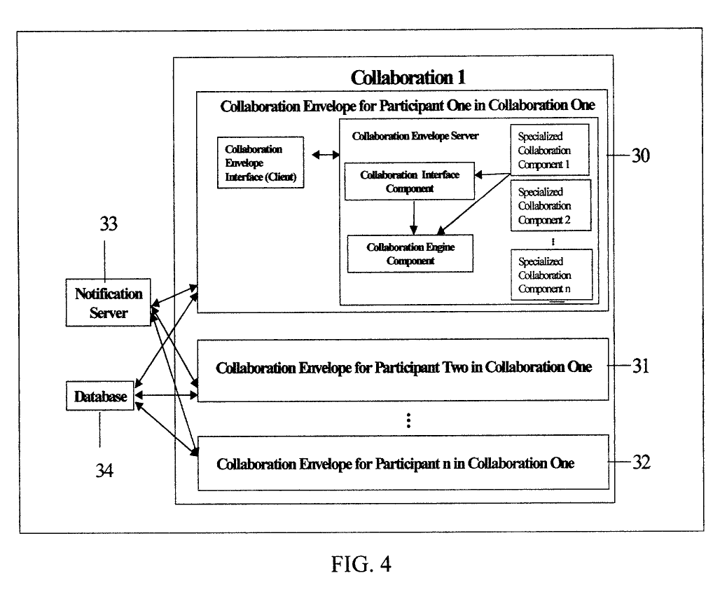

Referring now to FIG. 4, there is illustrated a diagram that shows a view of how each participating agent within a Collaboration has his or her or its own Collaboration Envelope™: Participant One has a Collaboration Envelope™ 30, Participant Two has a Collaboration Envelope™ 31 (not all components shown), up to any number of participants, participant n 32 has a Collaboration Envelope™. These Collaboration Envelopes™ connect to the Database and Notification Server as explained in FIG. 3.

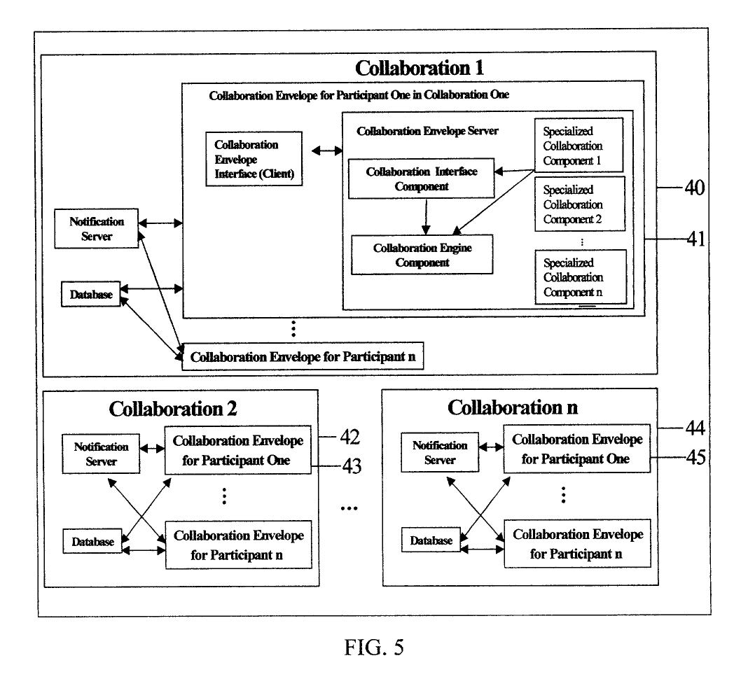

Referring now to FIG. 5, there is an illustrated diagram that shows a view of how a participating agent moves among Collaborations. Within Collaboration 1 40, Participant 1 has a Collaboration Envelope™ 41, within Collaboration 2 42, Participant 1 has a Collaboration Envelope™ 43, through some number, n Collaborations 44, Participant has a Collaboration Envelope™ 45.

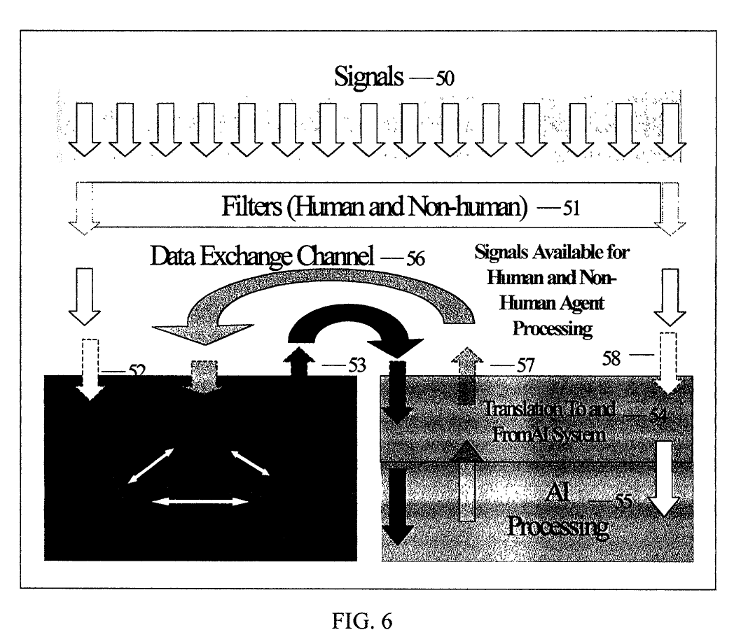

Referring now to FIG. 6, there is an illustrated diagram of an aspect of the invention that integrates a specialized Artificial Intelligence Collaboration Component within a Collaboration. A fundamental problem addressed in this aspect of the invention is the integration of advanced collaboration technology with advanced artificial intelligence technology. As noted earlier, for the most part, collaboration technology has focussed on overcoming limitations of people who can not be in the same place at the same time, and has not integrated advanced artificial intelligence techniques (Level 1 Collaboration Envelope™). At the same time, Artificial Intelligence (AI) has not integrated collaboration technology to enhance input to AI systems and to help make sense of output from AI systems. Signals 50 can be initially filtered using human and non-human agents 51. This means that the Artificial Intelligence Collaboration Component can be used with any filtering process and technology. Human agents access available signals (nodes of data) 52 and use judgment in making sense of these signals. Some of these signals that are enhanced through collaborative sensemaking 53 can then be used as input to the Specialized AI Collaboration Component, composed of a Translation Component 54 and AI Processing Component 55 via a Data Exchange Channel 56. A translation process must occur within the Translation Component 54 to make these signals meaningful to the AI Processing Component 55. Likewise, signals that result from AI Processing Component 57 can be made available for human agents to make sense of them by engaging in collaborative sensemaking around AI output. Also, the AI Processing Component 55 can accept signals that have not been collaboratively enhanced 58 and can return signals that are then available for processing 57 by collaborating human or non-human agents.

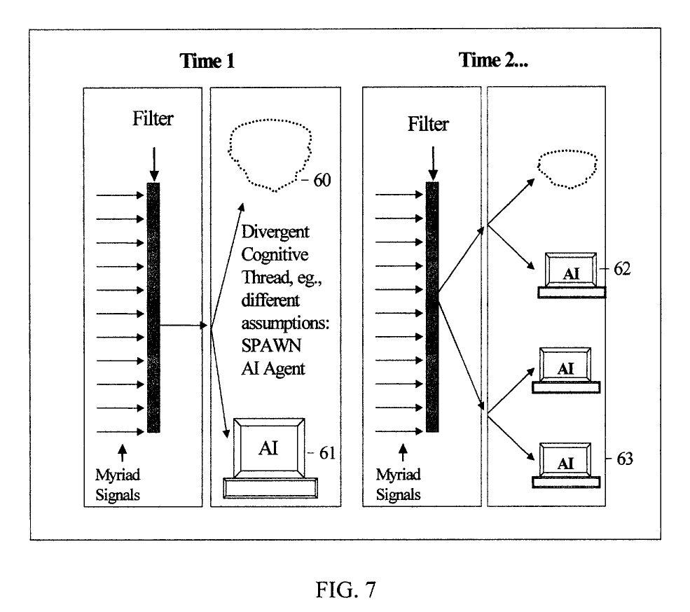

Referring now to FIG. 7, there is an illustrated diagram of aspect of the invention that directly addresses the limitation of individuals and groups to simultaneously follow multiple inference chains. At any time individual or collaborating human agents 60 will be able to initiate an AI Processing Component 61, 62 to follow a different perspective. The initialized Processing Component 61, 62 will then take input from multiple collaborating agents or directly from filtered signals through a translation mechanism as described in FIG. 6. AI Processing agents can also be spawned 63. This is similar to initiating, but the spawned AI Processing Component 63 takes on all characteristics of the parent AI Processing Component 61. The spawned AI Processing Component 63 will be duplicates of the parent AI Processing Component 61, but will then follow different paths with different input and provide different output available for human collaborating agents via the Data Exchange Channel as described in FIG. 6. It is possible that an AI Processing Component 61 can spawn itself based on its own internal reasoning structure.

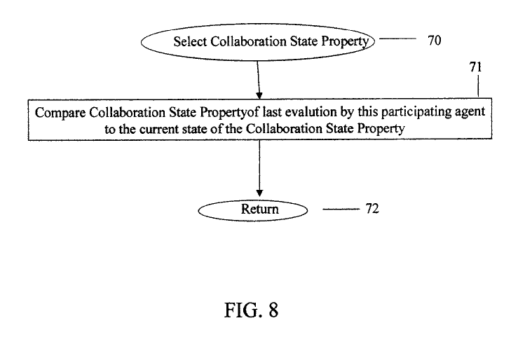

Referring now to FIG. 8, there is illustrated a flowchart depicting the Compare Operation of a Collaboration State Property between evaluations of the Property. The operation is initiated at a block 70 and then proceeds to block 71. Block 71 compares the Collaboration State Property from the last evaluation by the participating agent to the current state of the Property. Block 72 returns processing to where block 70 was initiated. While this flowchart depicts the last and current states of the Collaboration State Property, it's possible to select a particular state and compare it to another state.

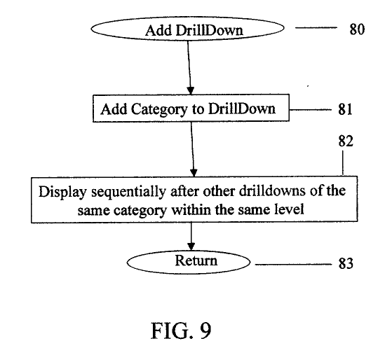

Referring now to FIG. 9, there is illustrated a flowchart depicting the dynamic labeling of drilldown files that permit categorization of rationale creation while creating the rationale within applications that cognitively supports the creation of the artifact. The operation is initiated at block 80 and then proceeds to block 81. In Block 81, the user names the drilldown file in an ad hoc manner. In the current implementation, this is done by including the category within brackets before the name. Block 82 processes the name and places the drilldown sequentially within the same category of files at this level. Block 83 returns processing to where block 80 was initiated. While this flowchart depicts one way to categorize files in an ad hoc fashion. The process of dynamically creating categories and linking files can be incorporated in a number of ways, including incorporating it into the standard Explorer within the Windows Operating System.

In summary, there has been provided a Collaboration Envelope™ Process and Architecture that provides collaboration functionality to support sensemaking capabilities of participating agents within a collaboration and among collaborations. A major innovation of the Collaboration Envelope™ Method is the way it enhances the ability of participating agents to maximize their sensemaking effectiveness as they work within a collaboration and then support the shifting among collaborations. Each participating agent may initiate Collaboration Envelopes™ within many collaborations. It is possible to have multiple Collaboration Envelopes™ initiated simultaneously to support shifting among collaborations. Collaboration Envelopes™ can maintain Collaboration State Properties with customized views for each participating agent so that participating agents may ascertain what has changed in collaboration state properties since the last time that the participating agent evaluated them. Within Collaboration Envelopes,™ files can be dynamically categorized to support rationale building that occurs within sensemaking. A specific example of a customized collaboration component, an AI processing component, integrates with standard Collaboration Envelope™ Components to collaboratively enhance input to and output from AI Processing Components. The Collaboration Engine Server interacts with a database in a conventional manner to persist information.

Although the preferred embodiment has been described in detail, it should be understood that various changes, substitutions, and alterations could be made therein without departing from the spirit and scope of the invention. The collaboration engine server interacts with a database in a conventional manner to persist information.

Although the preferred embodiment has been described in detail, it should be understood that various changes, substitutions, and alterations could be made therein without departing from the spirit and scope of the invention.

What is claimed is:

1) A method of building Collaboration Envelopes™ to support sensemaking, comprising the steps of:
a) providing a memory that is able to store data at a series of addresses in said memory,
b) providing an input means that at least one agent can use to store data in said memory at said respective series of addresses,
c) storing said data in said memory at said series of addresses,
d) providing an output device which is operatively connected to said memory for presenting to an output space of at least one dimension discernable to at least one agent, said data stored in said memory at said series of addresses,
e) providing a means that at least one agent can manipulate to initiate a Collaboration Envelope™ to support the sensemaking state of a participating agent within a collaboration.

2) The method of initiating a Collaboration Envelope™ of claim 1, further including a means to have multiple Collaboration Envelopes™ active simultaneously for a participating agent.

3) The method of initiating a Collaboration Envelope™ of claim 1, further including a means to shift from one Collaboration Envelope™ to another Collaboration Envelope™.

4) The method of initiating a Collaboration Envelope™ of claim 1, further including a means to have Collaboration Envelopes™ initiated on any machine as long as there is a Collaboration Envelope™ Interface (Client) that can interact with the Collaboration Envelope™ Server Components

5) The method of initiating a Collaboration Envelop™ of claim 1, further including a means for participating agents within a Collaboration to generate Signals Out from their sensemaking process at the right time and to the right participating agents.

6) The method of initiating a Collaboration Envelope™ of claim 1, further including a means for participating agents within a Collaboration to access Signals In to their sensemaking process at the right time and from the right participating agents.

7) The method of initiating a Collaboration Envelope™ of claim 1, further including a means for participating agents within a Collaboration to help them make sense and integrate Signals In within their sensemaking process.

8) The method of initiating a Collaboration Envelope™ of claim 1, further including the means to help achieve changes in state between engagements within a collaboration by ascertaining the changes in Collaboration State Properties for a participating agent from one engagement within a collaboration to another engagement within a collaboration.

9) The method of initiating a Collaboration Envelope™ of claim 1, further including a means to dynamically build categories for files to support rationale building that occurs within sensemaking.

10) The method of initiating a Collaboration Envelope™ of claim 1, further including a means to integrate Customized Collaboration Components within the Collaboration Envelope™.

11) The method of integrating Customized Collaboration Components of claim 10, wherein said means adds a Customized Collaboration AI Processing Component where inputs to and outputs from the AI Processing Component are enhanced through collaboration
